(19) United States
(12) Patent Application Publication
(10) Pub. No.: US 2026/0187069 A1
(43) Pub. Date: Jul. 2, 2026

(54) FUNCTION PLANNING

(71) Applicant: Intuit Inc., Mountain View, CA (US)

(72) Inventors: Dusan BOSNJAKOVIC, Los Angeles, CA (US); Prarit LAMBA, San Diego, CA (US); Shivakumara NARAYANASWAMY, San Jose, CA (US); Anmol JOSHI, San Diego, CA (US)

(21) Appl. No.: 19/001,933

(22) Filed: Dec. 26, 2024

(51) Int. Cl. G06F 16/2453

(52) U.S. Cl. CPC G06F 16/24542

(57) ABSTRACT

Certain aspects of the disclosure provide techniques for a language mode (LM) based service. An example method includes receiving, as input, a user query; identifying a set of first function schemas corresponding to a set of first functions, the set of first functions satisfying a similarity score threshold to the user query; determining whether the user query satisfies an ambiguity threshold with regard to selection of one or more functions from the set of first functions; (1) obtaining a user input associated with a clarification or completion of the user query, identifying a set of second functions based on the user input, and selecting the one or more functions from at least the set of second functions, or (2) selecting the one or more functions from the set of first functions; generating a function plan based on the one or more functions; and executing the function plan.

### BACKGROUND

### Field

Aspects of the present disclosure relate to systems and methods for generating a function plan using generative artificial intelligence.

### Description of Related Art

Generative artificial intelligence (GenAI) refers to machine learning models that are able to create new content based on patterns and information learned from training data in combination with a user prompt. The user prompt provides instruction to the model on what new content to generate and how to generate that new content. Notably, the model is able to generate new content based on both the actual information (e.g., facts, knowledge) included in the training data, as well as patterns, insights, and model parameter weights learned from the training data.

GenAI models are able to generate new content in many different forms, including text, image, audio, and even video. For example, to facilitate text generation, some GenAI models are configured as language models (LMs). An LM is generally a type of machine learning model that is designed to understand, generate, and manipulate human language. More specifically, an LM is a probabilistic framework that determines the likelihood of a sequence of words or tokens. At its core, a LM attempts to predict the probability of the next word in a sentence given the preceding words. The model estimates these probabilities based on the patterns it learned during training. LMs are useful in natural language processing (NLP) and computational linguistics for performing a range of tasks involving human language.

LMs have a wide array of applications, including: text generation (e.g., producing coherent and contextually appropriate text; machine translation (e.g., converting text from one language to another); speech recognition (e.g., converting spoken language into text); text summarization (e.g., condensing a long piece of text into a shorter summary); sentiment analysis (e.g., determining the sentiment expressed in a piece of text); and question answering (e.g., automatically providing answers to questions posed in natural language).

While language models represent a transformative force in many industries by assimilating vast amounts of knowledge, such as to build conversation-driven applications, these models are not without limitation. For example, while a powerful tool, an LM may produce outputs of limited utility when inputs lack sufficient information to enable the LM to generate a useful output.

### SUMMARY

Certain aspects provide a computer-implemented method performed by a processing system comprising a language model (LM) based service. The method includes receiving, as input, a user query; identifying a set of first function schemas corresponding to a set of first functions, the set of first functions satisfying a similarity score threshold to the user query; determining whether the user query satisfies an ambiguity threshold with regard to selection of one or more functions from the set of first functions; based on the user query satisfying the ambiguity threshold with regard to selection of the one or more functions: obtaining, by the LM-based service, a user input associated with a clarification or completion of the user query, identifying a set of second functions based on the user input, and selecting the one or more functions from at least the set of second functions; generating a function plan based on the one or more functions; and executing the function plan.

Certain aspects provide a computer-implemented method performed by a processing system comprising a LM based service. The method includes receiving, as input, a user query and a set of first function schemas corresponding to a set of first functions, the set of first functions satisfying a similarity score threshold to the user query; determining that the user query satisfies an ambiguity threshold with regard to selection of one or more functions from the set of first functions; based on whether the user query satisfies the ambiguity threshold with regard to selection of the one or more functions: obtaining a user input associated with a clarification or completion of the user query, identifying a set of second functions based on the user input, selecting the one or more functions from at least the set of second functions; generating a function plan based on the one or more functions and using one or more function schemas corresponding to the one or more functions; and providing the function plan for execution.

Certain aspects provide a method by a processing system. The method includes receiving, as input, a user query; identifying a set of first function schemas corresponding to a set of first functions, the set of first functions satisfying a similarity score threshold to the user query; selecting the one or more functions from the set of first functions, or from at least a set of second functions, based on whether the user query satisfies an ambiguity threshold with regard to selection of one or more functions from the set of first functions; generating a function plan based on the one or more functions, the function plan including a function definition, the function definition including computer code that defines a function name of the one or more functions and a function argument of the one or more functions; and executing the function plan.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a computing system configured to perform plan validation.

FIG. 2 depicts a flowchart diagram of a method for disambiguating a user query in connection with generation of a function plan.

FIG. 3 depicts an example of a function schema, a function plan and a function definition.

FIG. 4 depicts another example of a function schema.

FIG. 5 depicts another flowchart diagram of a method for disambiguating a user query in connection with generation of a function plan.

FIG. 6 is a diagram illustrating an example of a function plan.

FIG. 7 depicts a method by a processing system comprising an LM based service.

FIG. 8 depicts another method by a processing system comprising an LM based service.

FIG. 9 depicts another method by a processing system.

FIG. 10 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Automated assistants are applications that can be used to provide users with product and/or service assistance in a comprehensive and cost-effective manner. One type of automated assistant comes in the form of a chatbot, which is a software feature designed to simulate a conversation with human users. The chatbot is typically configured as a text-based user interface, much like a smart-phone's text messaging user interface, where a user is able to type an input which is submitted to the software and the software outputs a response to the user input. In some configurations, the inputs and outputs appear as distinct text bubbles in sequential order as a means to display the conversation to the user.

In some cases, automated assistants are configured to provide responses to user inputs based on a preset or rule-based conversation response. Rule-based automated assistants use if/then logic to respond to the user input based on a previously generated map of potential user inputs and corresponding outputs thought to be helpful in responding to the user inputs. Such automated assistants can also access pre-approved content databases to retrieve additional information or links to provide other helpful information to the user if the previously generated rule matches one of the content datasets included in the pre-approved content databases. While these rule-based automated assistants provide consistent and pre-vetted responses to users, such assistants are constrained and limited in their ability to provide tailored and customized responses to user inputs, especially when the user inputs do not match well to any of the pre-defined rules or conversation maps. For example, if a user input is not addressed by a pre-defined rule or conversation map, a rule-based automated assistant may provide an error, fail to process the user, and/or escalate to a human intervention, which is resource-intensive and impacts user experience.

In order to improve the quality and customization of outputs, automated assistants may employ different machine learning models, such as language models (LMs), that can be trained to generate responses to different user questions or queries. Some LMs are trained specifically for text generation, often referred to as large language models (LLMs) because of the extensive amount of data on which they are trained and the size of these models relative to other LMs. LMs are configured to receive a user input (e.g., user query) that requests a text output from the model. The LM then generates a text output based on the user input using the information, context, and model parameter weighting learned during the LM's extensive training process.

In addition to generating text outputs, users may request an automated assistant to perform one or more specified actions, including accessing databases, generating or transmitting documents, or other tasks. For example, a user may request that the automated assistant gather information and then generate a document, such as a report or email, to fill in a form. To facilitate the completion of these actions or tasks, an automated assistant can be configured to access function databases that store different functions, or to use application programming interfaces (APIs) to call functions to perform various tasks. These functions can be static or rule-based functions, machine learning-based functions, or even generative functions using LLMs described above. Functions are typically defined based on a function schema, which includes the function name, arguments (e.g., function inputs), the function code, and function outputs. Each argument may associated with at least a value and a type (e.g., string, integer, etc.). Each value and/or type may be associated with an acceptable range, list, or other boundaries defined in the function schema to ensure proper functionality and accurate outputs of the function.

Thus, some automated assistants may be configured to use a combination of both generative models and other functions to be able to generate high quality, tailored responses for a wide range of different user inputs. However, challenges arise with the usage of LM-based assistants, including LLM-backed automated assistants, such as ensuring that the LM-based assistant is provided with the information it needs in order to generate useful outputs, and creating outputs that can be executed without human intervention given unstructured input.

For example, a processing system receives a user query. The processing system selects a set of functions from a plurality of available functions based on the user query. The processing system can use information provided in function schemas of these functions to generate computer code that enables the functions to be executed (the computer code that enables a function to be executed is referred to herein as a function definition for that function). However, in some cases, the processing system may have insufficient information from the user query to generate a function description for a given function. For example, the user query may include a request to upload a form, but a function for uploading a form may receive a specific form as input. In this situation, generation of a function definition for the function will fail since the processing agent does not have sufficient information to generate the function, which leads to usage of processing resources associated with indicating the failure and costs associated with escalating to human intervention. Furthermore, using predefined questions or a predefined algorithm such as a decision tree to resolve such ambiguity may be inefficient since the predefined questions or algorithm may fail to take into account the sort of information that is missing, and since user queries can be variable in content and form (leading to a lower success rate for predefined questions or algorithms).

Furthermore, some user queries are not resolvable using a single function. For example, a user query may request a task that involves an output that cannot be generated by a single function. In this situation, if the processing system generates a function definition that invokes a single function in response to the user query, processing resources may be expended in connection with the user providing further user queries to advance the task to completion, or in connection with the processing system failing to properly configure completion of the task indicated by the user query.

Systems and methods are described herein which overcome the aforementioned technical problems and improve upon the state of the art by providing disambiguation of user queries in connection with generating a function plan, and by providing generation of a function plan that includes multiple functions which can be executed in parallel or in series.

For example, as described above, the processing system can identify a first set of functions in response to a user query. While generating a function plan using the first set of functions, the processing system identifies that an ambiguity threshold is satisfied. The ambiguity threshold indicates that the user query lacks information that the processing system can use to generate a function description for a function of the first set of functions. Based on the ambiguity threshold being satisfied, the processing system may use an LM (such as an LM-based service) to obtain a user input associated with a clarification or completion of the user query. For example, the LM may generate a clarification request to obtain the clarification or completion via a user input. Thus, processing usage associated with failing to generate a function definition due to a lack of information in the user query is reduced, and effectiveness of generation of function definitions is improved.

In some aspects, the processing system uses the user input to identify a second set of functions. For example, the processing system may perform query augmentation (as described with regard to microservice 104(1), identify a second set of functions based on semantic similarity determination and filtering (as described with regard to microservice 104(2), and may use the second set of functions (and optionally the first set of functions) to generate a function plan. This improves the accuracy of function selection, thereby improving outcomes with regard to function plan selection and reducing processing resource usage associated with the user repeatedly running the function plan generation to attempt to obtain better outcomes. Notably, in some aspects, the original user query, the first set of functions, the clarification request, and the second set of functions all remain within a context window of the processing system (e.g., the LM), which improves accuracy and usability of function plan generation.

In some aspects, the processing system generates a function plan that includes a planning strategy. The function plan includes multiple function descriptions, and the planning strategy indicates how multiple functions, corresponding to the multiple function descriptions, are executed. For example, the planning strategy may indicate a series of functions according to outputs of earlier functions in the series and inputs of later functions in the series. As another example, the planning strategy may indicate a set of functions to be executed in parallel based on the set of functions not having dependencies on one another with regard to inputs and outputs. The function plan, including the multiple function descriptions, is generated so that the function descriptions, when executed, implement the planning strategy by executing the series of functions in series and/or the set of functions in parallel. Thus, a function plan that involves the execution of multiple functions can be generated by the processing system using the LM. This reduces processing resource usage relative to an approach where function plans include only a single function, by reducing the number of user queries, iterations of the LM, and so on. Furthermore, by gracefully generating a function plan that enables the execution of the multiple functions, user intervention is reduced, further conserving processing resources by reducing error rate and improving efficiency of function plan generation.

### Example Computing Environment

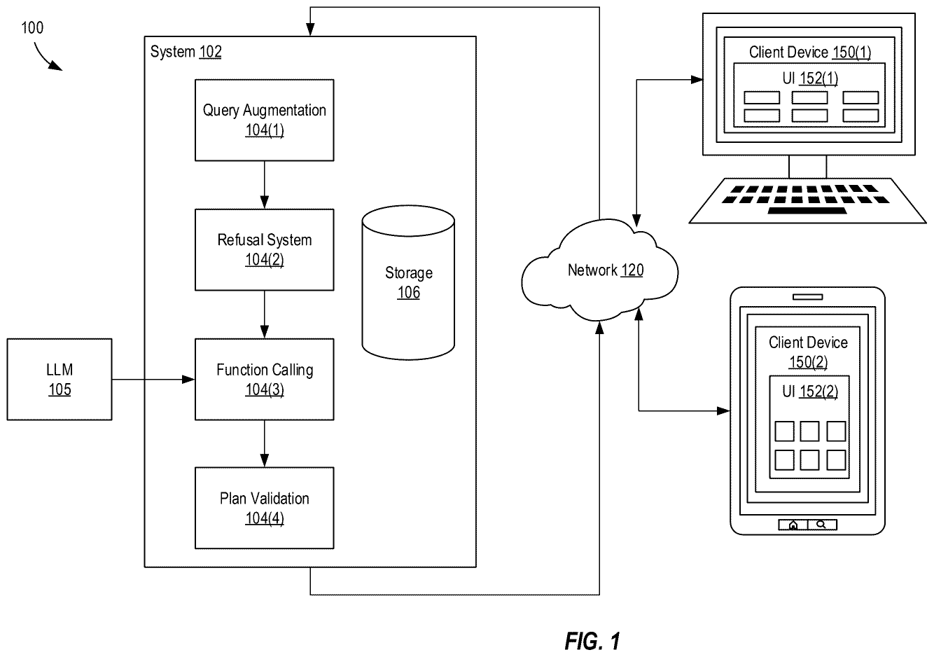

FIG. 1 depicts an example system 100 comprising a sub-system (e.g., system 102) in communication with a machine learning model (e.g., LLM 105) and one or more client devices (e.g., client device 150(1)-(2)). System 102 further comprises one or more microservices 104 that are implemented in series but also can be independently deployable services (or software) that may make up an application. Microservices 104 may enable segmented, granular level functionalities within a larger system infrastructure.

As shown in FIG. 1, system 100 comprises client devices 150(1)-(2) (collectively referred to herein as “client devices 150”) and system 102 interconnected through a network 120. Network 120 may be, for example, a direct link, a local area network (LAN), a wide area network (WAN), such as the Internet, another type of network, or a combination of one or more of these networks.

System 102 may be constructed on a server grade hardware platform and include components of a computing device such as, one or more processors (central processing units (CPUs)), one or more memories (random access memory (RAM)), one or more network interfaces (e.g., physical network interfaces (PNICs)), storage 106, and other components (e.g., only storage 106 is shown in FIG. 1).

System 102 in system 100 may host a plurality of microservices 104(1)-(4) (collectively referred to herein as “microservices 104”). The microservices 104 may be deployed using virtual machines (VMs) and/or container(s) running on system 102 (e.g., where system 102 is running a hypervisor (not shown) used to abstract processor, memory, storage, and networking resources of system 102 hardware platform).

Client device 150(1) and client device 150(2) may each include a user interface (UI) 152(1), 152(2), respectively, which may be used to communicate with, at least, a first microservice 104(1), a second microservice 104(2), and/or a third microservice 104(3) using the network 120. For example, communication between client devices 150 and a microservice 104 may be facilitated by one or more application programming interfaces (APIs). Examples of client devices 150 may include a smartphone, a personal computer, a tablet, a laptop computer, and/or other devices.

As shown in FIG. 1, the microservices 104 may include, at least, the first microservice 104(1), the second microservice 104(2), the third microservice 104(3), and the fourth microservice 104(4).

In certain embodiments, the first microservice 104(1) implements a query augmentation system. The query augmentation system parses user queries to identify sub-queries, add information or context as appropriate, and format the sub-queries or user query in a fashion appropriate for subsequent processing. Additionally, the second microservice 104(2) implements a refusal system. In some aspects, the refusal system applies function-specific thresholds to semantic scores of corresponding functions at run-time to narrow down the list of potential functions input to the third microservice 104(3). By implementing run-time filtering, the refusal system ensures that only the most relevant function are considered for the final planning stage by filtering out less relevant functions based on corresponding semantic scores not meeting the function-specific thresholds. The third microservice 104(3) implements a function calling system that performs function API contract building to construct API contracts (e.g., as part of function definitions) to call the appropriate function, disambiguation to resolve any ambiguities in the user queries or API functions, and creating planning strategies to determine the sequence and nature of API calls or functions to respond to the user query. The fourth microservice 104(4) implements a plan validation system, which facilitates hallucination detection and function argument disambiguation to clarify and correct any hallucinations in the arguments used by the functions at run-time.

Though FIG. 1 depicts each of system 102, storage 106, client device 150(1), and client device 150(2) as single devices for ease of illustration, system 102, storage 106, client device 150(1), and/or client device 150(2) may be embodied in different forms for different implementations. Further, though FIG. 1 depicts only a single sub-system (e.g., system 102) and two client devices 150, other embodiments may include more or less sub-systems and/or client devices 150, and client devices 150 may use any combination of microservices 104 on any system 102 where microservices 104 are deployed.

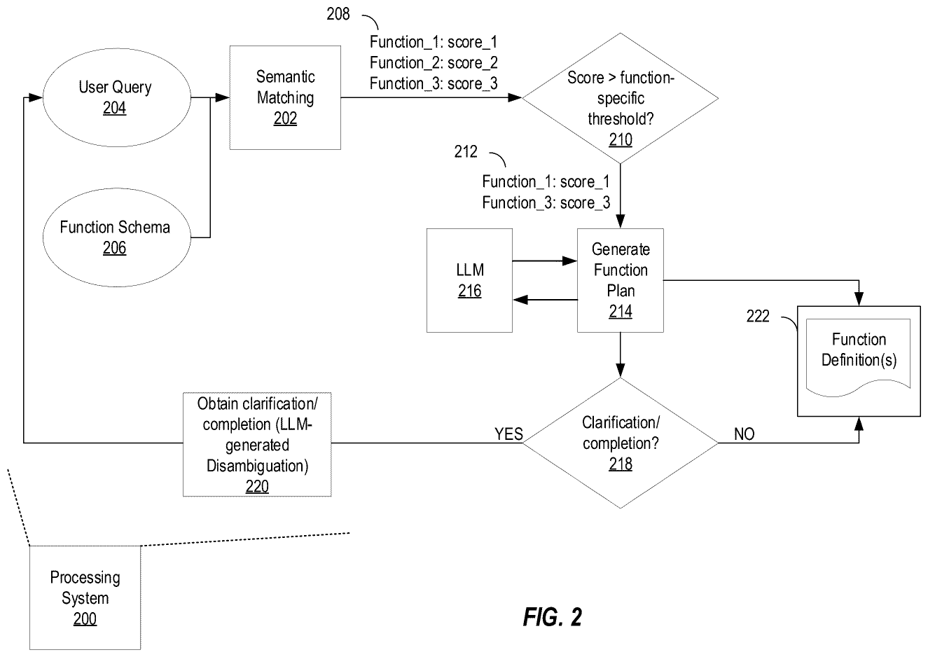

FIG. 2 depicts a flowchart diagram of a method for disambiguating a user query in connection with generation of a function plan. In some aspects, the operations of FIG. 2 may be performed by a processing system 200, such as system 100, system 102, microservice 104, client device 150, or processing system 1000. The processing system 200 implements an LM-based service, such as an LLM-based assistant using an LLM 216 (e.g., LLM 105). For example, one or more operations of flowchart diagram 200 may be performed by the LLM 216.

As an overview of components and elements illustrated in FIG. 2, a set of inputs are provided to or obtained by a processing system 200. The set of inputs includes user query 204 and function schema 206. User query 204 comprises user input that is received at a user interface, such as one of user interfaces 152 of FIG. 1. The user interface is configured to facilitate a user's interaction with an automated assistant. For example, a user may access a chatbox user interface associated with or provided by the automated assistant and submit a user query 204 that prompts the automated assistant to help with one more tasks. Some example tasks include asking for help in uploading a form or requesting additional information. The user query 204 can be received in any form, such as text input via a chatbox, audio input, or the like.

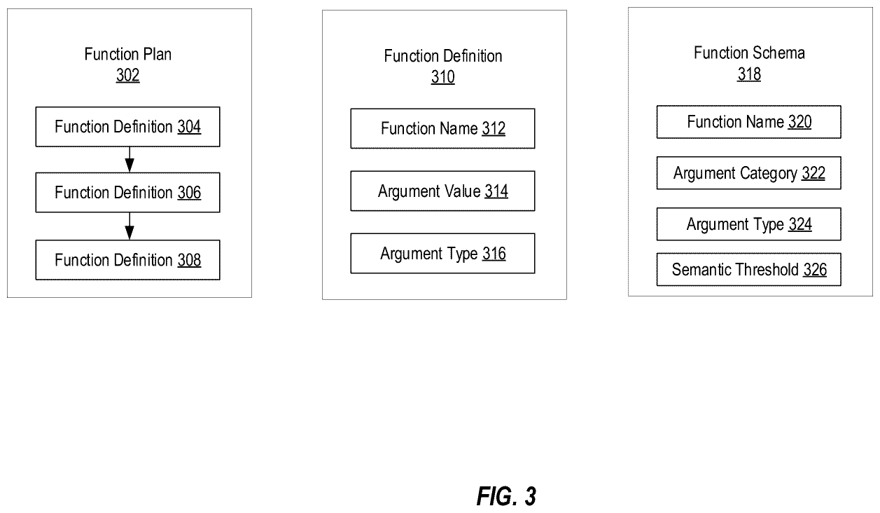

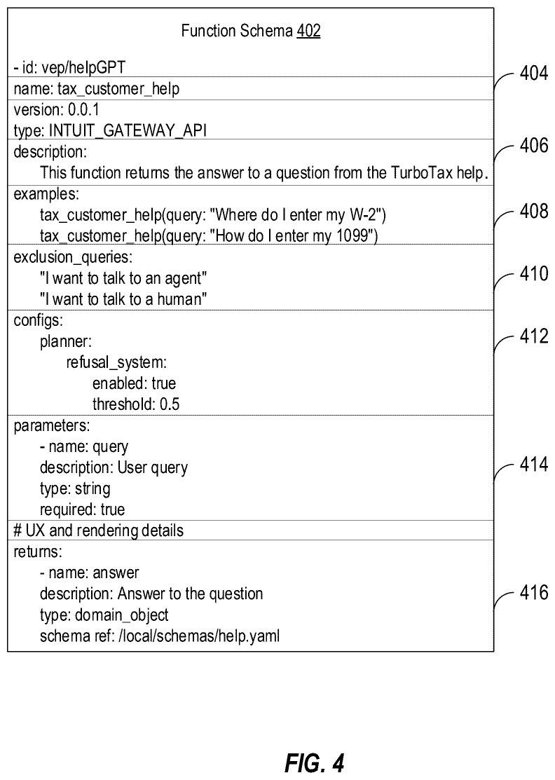

Additionally, function schema 206 is provided as input to help facilitate the semantic analysis of the user query 204 and to assist the LLM 216 in understanding how to access and execute the corresponding function. The function schema 206, shown in further detail as function schema 318 in FIGS. 3-4, comprises features associated with a particular function that can be executed as part of a function plan. The function schema 206 is used in diagram 200 to perform semantic matching, function plan generation, and disambiguation, as described below.

FIG. 3 provides an example of a function schema 318, as well as a function plan 302 and a function definition 310 (which are described later). Function schema 318 (representative of function schema 206) is shown comprising a function name 320, an argument category 322, an argument type 324, and a semantic threshold 326. A function name 320 is an identification label associated with a particular function. The function name 320 may be used to call or execute the function. An argument category 322 is a classification of arguments that are used as inputs to the function. An argument type 324 is a type of argument that is compatible with the functionality of the function (e.g., integer, string, binary, etc.). For example, if the function definition 310 is “upload (form: 1098)”, the function name is “upload”, the argument category is “form”, and the argument type is “string.” Additionally, an argument value may be included in the function definition 310. An argument value is a specific value of an argument to be passed as input to a function. For example, an argument value of “1098” may refer to the 1098 form. In the function definition “upload (form: 1098)”, “1098” is correctly formatted as an string, as required by the function schema for the “upload” function.

A semantic threshold 326 indicates a threshold for a similarity score between a function associated with the function schema 318, and a user query (e.g., user query 204). If the similarity score satisfies the semantic threshold 326, the processing system includes the function schema 318 (or information identifying the function schema 318 or a function associated with the function schema 318) in an input to a function planning component 214. If the similarity score fails to satisfy the semantic threshold 326, the processing system does not include the function schema 318 (or information identifying the function schema 318 or the function associated with the function schema 318) in the input to the function planning component 214. Function planning component 214 may include or be implemented as a function calling component, such as microservice 104(3), and may include or be implemented as an LM-based service. Function planning component 214 generates a function plan, which may include a set of (one or more) function definitions and/or a planning strategy, based on a set of functions input to function planning component 214.

FIG. 4 provides another example of a function schema 402. The function schema 402 (representative of function schema 318) provides information about a specific function that returns an answer to a question from an automated assistant (e.g., “help chatbot”). Function schema 402 comprises a function name 404 (e.g., “tax_customer_help”), function parameters 414, such as an argument category (e.g., “query”), argument type (e.g., “string”), and/or other details about the function. Other function parameters include a description of the argument category (e.g., “User query”) and whether the argument is required or optional (e.g., “required: true”). Function schema 402 also includes a function description 406 (e.g., “This function returns the answer to a question from the TurboTax help”), examples 408 of the function definition associated with executing the function (e.g., tax_customer_help(query: “Where do I enter my W-2”)), and examples of exclusion queries 410 (such as “I want to talk to an agent” or “I want to talk to a human”) that indicate a user's escalation when interacting with the automated assistant. “Escalation” refers to a type of user interaction with the automated assistant that indicates that the user wishes to interact with a human representative, instead of the automated assistant. This typically occurs when the user does not find the responses from the automated assistant to be helpful or when the tasks being asked of the automated assistant are beyond the capabilities of the automated assistant.

Function schema 402 also comprises configuration features 412 and return features 416. The configuration features 412 include a feature indicating that a refusal system is enabled for the function schema 402. This may mean that the function schema 402 is subject to filtering according to semantic scores. The configuration features 412 also include a feature indicating a similarity score threshold of 0.5 (“threshold: 0.5”). The return features 416 comprise details about what output(s) the function will return after execution. As shown in FIG. 4, return features 416 comprise a name associated with the return (e.g., “answer”), a description of the return (e.g., “Answer to the question”), a type associated with the return (e.g., “domain_object”), and schema reference/storage location details (e.g., “/local/schemas/help. yaml”). The information and features included in the function schema 402 are structured to help an LLM (e.g., LLM 216) understand how to interact with the function without human intervention.

Function plan 302 depicted in FIG. 3 comprises a plurality of function definitions (e.g., function definition 304, function definition 306, and function definition 308), which may be examples of function definition 310. A function definition is an output of the function planning component 214 comprising computer code that triggers or executes a corresponding function, and is described in more detail elsewhere herein. When more than one function definition is included in the function plan, the function plan also comprises a planning strategy that determines the order in which the functions should be executed.

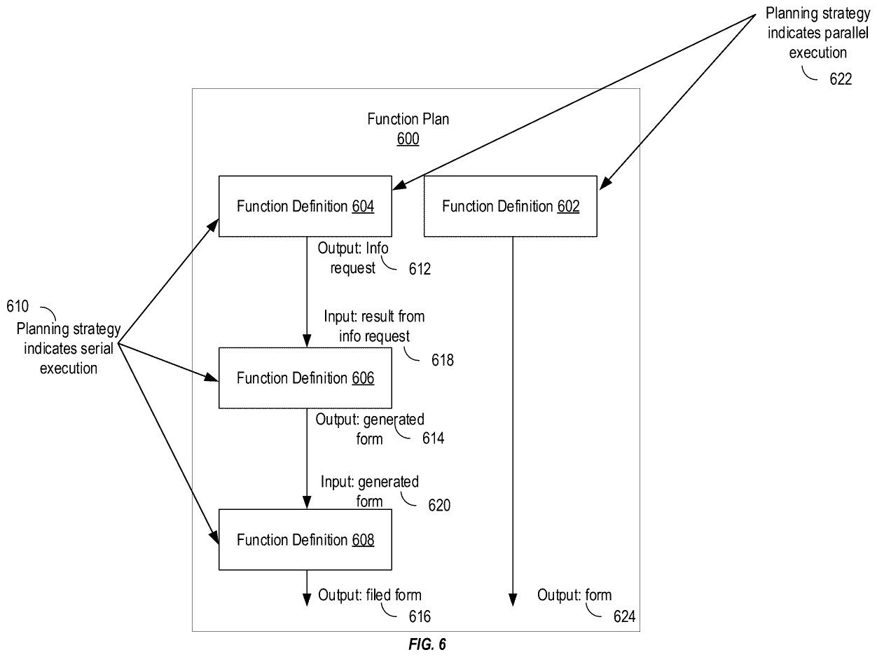

The planning strategy can determine a parallel or a series-based execution. The planning strategy takes into consideration (or may be generated based on) dependencies between the different functions, such as if an output from one function corresponds to the input specified for a different function. For example, as illustrated in FIG. 3, the arrows between the function definitions indicate that the order of operation of the functions associated with the function definitions is as follows: function definition 304 will be executed first, followed by the function associated with function definition 306, and then followed by the function associated with the function definition 308. The planning strategy ensures that the functions are executed in the correct order to prevent errors in function outputs or fail states of the different functions. Additional description of a planning strategy is provided in connection with FIG. 6.

Returning to FIG. 2, a semantic matching component 202 determines semantic scores based on the user query 204 and the function schemas 206. For example, the semantic matching component 202 may receive, as input, a function manifest that includes the function schemas 206. The semantic matching component 202 determines semantic scores based on the function schemas 206 and the user query 204. A semantic score for a given function schema 206 indicates how semantically similar content of the given function schema 206 is to content of the user query 204.

In some aspects, the processing system (e.g., semantic matching component 202) may generate embeddings of the user query 204 and the function schemas 206. For example, the embeddings may include first embeddings associated with (e.g., derived from) the user query 204 and second embeddings associated with (e.g., derived from) the function schemas 206. In some aspects, the embeddings are generated using an LM, such as a transformer-based LM. The LM includes or utilizes a tokenizer that has been trained on input information. This tokenizer provides for the input text to be used to generate (e.g., broken down into) tokens that the LM can understand and process efficiently. In some aspects, the processing system tokenizes multiple aspects of a function schema 206. For example, the processing system may tokenize a function name 404, a function description 406, examples 408, or a combination thereof.

Once the user query 204 and function schemas 206 are tokenized, the processing system converts these tokens into vector representations, known as embeddings. These embeddings capture or represent semantic meaning of the user query 204 and the function schemas 206, allowing the processing system to understand the context and relationships between different elements of the user query 204 and the function schemas 206. In some aspects, the processing system generates embeddings for multiple aspects of a function schema 206. For example, the processing system may generate respective embeddings for a function name 404, a function description 406, examples 408, or a combination thereof. In some aspects, these embeddings of the function schema 206 may be generated prior to runtime and stored. For example, the processing system may store a database of embeddings derived from function schemas 206 available to the processing system, thereby reducing latency and processing burden at runtime.

The similarity scores may include, for example, cosine similarity scores or the like. To determine the similarity score between a user query 204 and a function schema 206 (or a feature of a function schema 206), the processing system calculates a metric such as a cosine similarity. A cosine similarity metric measures the cosine of the angle between two vectors (in this case, embeddings of the user query and the function schema or feature) in a multi-dimensional space, providing a value that indicates how closely related the two embeddings are. A higher cosine similarity score suggests that the user query 204 and the function schema 206 or feature are more semantically aligned. In some aspects, a given function schema 206 is associated with multiple similarity scores. For example, the processing system may determine a respective similarity score for each of a function name 404, a function description 406, examples 408, or a combination thereof. Generating the multiple similarity scores improves the likelihood that semantic similarity is properly determined for a given user query 204. For example, in some cases, an example 408 may be more semantically similar to a user query 204 than a function name 404, and may provide a better measure of true similarity than the function name 404. Using the multiple similarity scores improves flexibility and resilience to variable user queries 204.

As shown, at 208, the semantic matching component 202 outputs a set of similarity scores for a set of functions (including Function_1, Function_2, and Function_3). In some aspects, a similarity score is generated by combining multiple similarity scores. For example, a similarity score for a given function may be generated by combining (e.g., averaging, taking a median of) similarity scores derived from a function name 404, an example 408, and a function description 406 of the given function. As another example, a similarity score for a given function may use a highest (e.g., indicating a highest similarity) similarity score of similarity scores derived from a function name 404, an example 408, and a function description 406 of the given function.

In some aspects, the processing system generates the similarity scores using a supervised model. For example, the supervised model may include an LM. The supervised model may be trained on labeled historical data, such as a training set of user queries, function schemas, and similarity scores corresponding to user-query-function-schema pairs. This training may be performed using any suitable machine learning algorithm. The supervised model may receive, as input, a user query and a function schema. The supervised model may output a similarity score corresponding to the user query and the function schema.

At 210, the processing system determines if a similarity score satisfies a function-specific threshold. As mentioned, the function-specific threshold for a given function is identified by a configuration feature 412, included in a function schema 402 of the given function, that defines the function-specific threshold.

In some aspects, the function-specific threshold, or the similarity score, may be based on a context window of the LLM. For example, the processing system may adjust a function-specific threshold or a similarity score so that a number of functions that are provided to the function planning component 214 fit within the context window. As another example, if the context window of the function planning component 214 (e.g., LLM 216) is exceeded, the function planning component 214 may provide a flag that indicates the context window has been exceeded, and the processing system may adjust the function-specific threshold or the similarity score to reduce the number of functions that are provided to the function planning component 214.

As shown, at 212, the processing system provides a subset of functions, of the set of functions for which the similarity scores were determined, that are associated with similarity scores that satisfy the function-specific threshold. For example, each function, of the set of functions, has a respective similarity score that satisfies a function-specific threshold of that function. The processing system provides the subset of functions to the function planning component 214. The subset of functions is referred to herein as a first set of functions.

As shown, the function planning component 214 generates a function plan 222. The function planning component 214 uses the user query 204 and the function schema 206 to generate the function plan 222. For example, the function planning component 214 may select, from a plurality of potential functions indicated by the subset of functions provided at 212, one or more functions based on the user query 204. The function planning component 214 selects this one or more functions based on the function schema 206. For example, the function planning component 214 (e.g., the LLM 216 of the function planning component 214) may compare the user query 204 and the function schema 206 to identify appropriate functions. The function planning component 214 then generates function API contracts (e.g., function descriptions) for each of the selected function(s) according to the function schema 206. For example, the function planning component 214 (e.g., the LLM 216) may extract parameters for a given function, such as a function name, function arguments, and an output of the function, from the function schema 206. The function planning component 214 uses these parameters to generate computer code that calls or triggers execution of the function. In some examples, as described herein in connection with FIG. 6, the function planning component 214 configures a series of functions to be executed in series, or a set of functions to be executed in parallel, based on inputs and outputs of the set of functions.

In some aspects, at 218, the processing system 200 (e.g., the function planning component 214) determines whether an ambiguity threshold is satisfied with regard to selection of one or more functions. If the ambiguity threshold is satisfied, this may indicate that the user query 204 provides insufficient information to generate a function description or function plan 222. For example, the ambiguity threshold may be satisfied when the user query 204 includes a request to upload a form, but a function for uploading a form may receive an argument that identifies a specific form (which is unspecified by the user query 204) as input.

More generally, the processing system 200 may determine if the ambiguity threshold is satisfied by reference to a function schema 206 and a user query 204. For example, when generating a function description or function plan 222 for a function, the processing system 200 may generate computer code that includes a function name, function arguments (e.g., defined by parameters 414), and any other inputs of a given function according to a function schema 206 of the function. The processing system 200 determines that the user query 204 does not include information specified by the function arguments. For example, the processing system 200 may determine that no content, from the user query 204, provides the information specified by the function arguments at a threshold level of confidence. In this situation, the processing system 200 determines that the ambiguity threshold is satisfied.

If the ambiguity threshold is not satisfied (block 218—NO), then the function planning component 214 outputs the function plan 222. If the ambiguity threshold is satisfied (block 218—YES), the processing system 200 obtains a clarification or completion (block 220). For example, the processing system 200 generates a request for the clarification or completion using the LLM 216. Continuing the above example, the request for the clarification or completion may request that the user provide a user input that indicates a specific form, such that the function description for the function can be successfully generated.

The processing system 200 generates the request for clarification or completion using LLM 216. For example, the request for clarification or completion may include an LLM-generated disambiguation. In some aspects, the processing system 200 provides the request for the clarification or completion for display or other interaction via a user interface. The processing system 200 receives a user input that includes the clarification or completion indicated by the request. The processing system 200 performs operations including determination of similarity scores by the semantic matching component 202 and filtering of functions according to similarity scores at 210. Thus, the processing system 200 determines a second set of functions, which may be the same as the first set of functions shown by 212, or may be different than the first set of functions.

In some aspects, the processing system 200 performs query augmentation for the second set of functions. Query augmentation includes query decomposition (in which a user query or user input is broken down into two or more sub-queries, such as by breaking down “What is 1099-B and how to import this” into two components of “What is 1099-B” and “How to import this?”). These sub-queries can then be routed to respective agents, functions, or components for further processing.

In some aspects, the LLM 216 of the function planning component 214 generates a function plan 222 in accordance with the user query 204 and a user input associated with a request for clarification or completion. For example, when generating the function plan 222, the LLM 216 may take into account the original user query 204, the first set of functions determined according to the user query 204, and any additional information obtained as a result of the request for clarification or completion. This additional information may include the user input, a sub-query obtained from the user input, similarity scores of a set of functions that are selected in accordance with the user input, a second set of functions that are based on the similarity scores, or a combination thereof. For example, the additional information, the user query 204, and the first set of functions, may be provided in a context window of the LLM 216.

The function planning component 214 generates the function plan 222 including one or more function definitions corresponding to one or more functions. When the clarification or completion is obtained (block 218—YES), the function planning component 214 selects the one or more functions from at least the second set of functions (and optionally also from the first set of functions). For example, the function planning component 214 identifies functions according to the user query 204 and the user input in response to the request for clarification or completion, such as by including all of this information in a context window of the LLM 216. When the clarification or completion is not obtained (block 218—NO), the function planning component 214 selects the one or more functions from the first set of functions.

The processing system 200 executes the function plan 222. For example, the processing system 200 executes the one or more function definitions such that one or more corresponding functions are run. This may be performed locally to the processing system 200, or at another processing system (e.g., another system 100, another system 102, another processing system 200, another microservice 104). For example, the processing system 200 may run the functions indicated by the function plan 222. As another example, the processing system 200 may provide the function plan 222 for execution at another device. As another example, the processing system 200 may execute the function plan 222, and may interact with another system in accordance with one or more function definitions of the function plan 222.

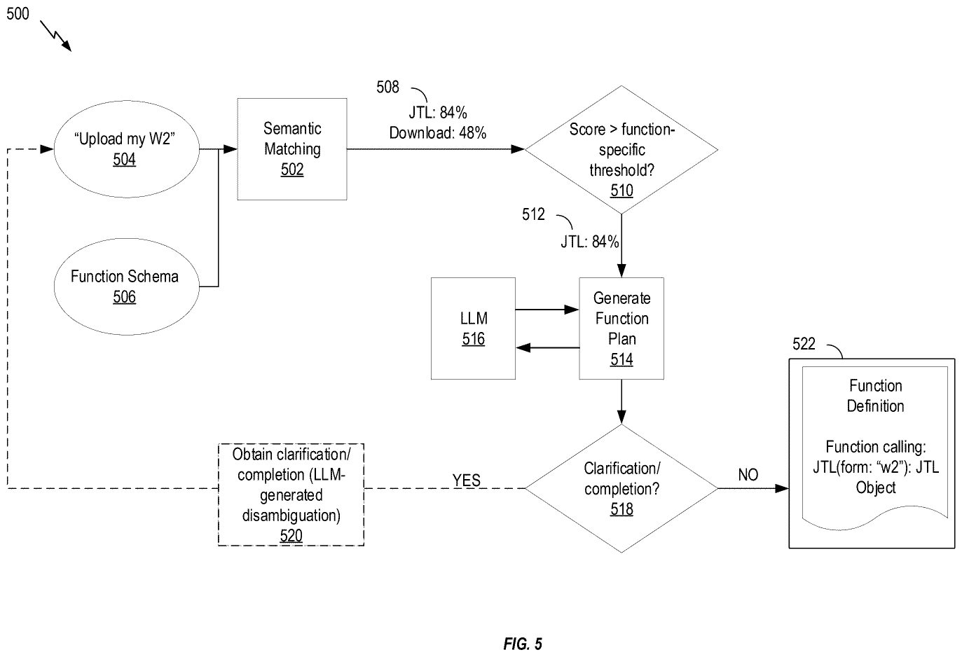

FIG. 5 depicts another flowchart diagram 500 of a method for disambiguating a user query in connection with generation of a function plan. In some aspects, the operations of diagram 500 may be performed by a processing system such as system 100, system 102, microservice 104, client device 150, processing system 200, or processing system 1000. The processing system implements an LM-based service, such as an LLM-based assistant using an LLM 516 (e.g., LLM 105).

As shown, the processing system receives a user query 504 (“Upload my W2”) and function schemas 506 corresponding to a set of functions. For example, the processing system may obtain a function manifest that includes the function schemas 506. In some aspects, the processing system may obtain a set of embeddings corresponding to the set of functions or the function schemas 506. For example, the processing system (e.g., semantic matching component 502, which may be an example of semantic matching component 202) may generate and store the set of embeddings (e.g., prior to receiving the user query 504). The processing system may further generate one or more embeddings for the user query 504, as described above.

As shown, the semantic matching component 502 determines semantic scores for the function schemas 506 (e.g., the set of functions corresponding to the function schemas 506). The semantic scores are shown at 508 for two example functions named “JTL” (with a score of 84%) and “Download” (with a score of 48%). Here, “JTL” is associated with a relatively higher similarity score than “Download,” since one or more parameters of the function schema 506 for “JTL” (such as examples from function schema 506 corresponding to “JTL”) are more semantically similar to the user query 504 than are one or more parameters of the function schema 506 for “Download.” As shown, at 510, the processing system determines whether the semantic scores shown at 508 satisfy corresponding function-specific thresholds. At 512, only the “JTL” function is passed to the function planning component 514 (which may be an example of function planning component 214) as a subset of functions, and the “Download” function is not passed to the function planning component 514. For example, only the “JTL” function may be passed to the function planning component 214 based on the similarity score of the “JTL” function satisfying a corresponding function-specific threshold, and based on the similarity score of the “Download” function failing to satisfy a corresponding function-specific threshold. By passing only the functions with similarity scores that satisfy the respective function-specific thresholds to the function planning component 514, the processing system reduces processing and memory resource usage relative to passing all of the functions identified by function schemas 506. Furthermore, the number of functions that can be included in the function schemas 506 without exceeding the context window size of the function planning component 514 is increased. Still further, filtering (e.g., refusal) can be implemented for functions in a less computationally expensive fashion than filtering the functions at the function planning component 514 (e.g., using an LLM 516). Furthermore, performance of the function planning component 514 is improved relative to an approach where functions are indiscriminately passed to the function planning component 514 without regard to a context window size of the function planning component 514.

As shown, the function planning component 514, using the LLM 516, generates a function plan 522. The function planning component 514 uses the user query 504 and the function schema 506 to generate the function plan 522. As shown, the function plan 522 includes a function definition for the “JTL” function. The function definition includes computer code that includes a name of the “JTL” function (JTL), an argument (“form”), and argument values (“w2” and “JTL object”).

In the flowchart diagram 500, no clarification or completion is needed for the user query 504. For example, the processing system determines at 518 that an ambiguity threshold is not satisfied for the user query 504 (block 518—NO). In some other examples, the processing system may determine at 518 that the ambiguity threshold is satisfied for the user query 504 (block 518—YES). For example, the ambiguity threshold may be satisfied if the user query 504 were to indicate “Upload a tax form.” When the ambiguity threshold is satisfied, at 520, the processing system generates (e.g., using LLM 516) a request for clarification or completion. The request for clarification or completion is configured to resolve ambiguity in the user query 504. For example, the request for clarification or completion may include a question such as “Which tax form do you intend to upload?”. Upon obtaining user input indicating the clarification or completion, the processing system may perform one or more operations of the flowchart diagram 500, such as semantic matching, determination of whether semantic scores of a second set of functions satisfy function-specific thresholds, and passing of the second set of functions to the function planning component 514 for generation of a function plan 522.

FIG. 6 is a diagram illustrating an example of a function plan 600. Function plan 600 includes function definitions 602, 604, 606, and 608. As shown at 610, the function plan 600 includes a planning strategy that indicates serial execution of functions corresponding to function definitions 604, 606, and 608. A function planning component (e.g., function planning component 214 or function planning component 514) generates the function plan 600 and the function strategy based on outputs and inputs of the function definitions 604, 606, and 608, function schemas of the function definitions 604, 606, and 608, and a user query (e.g., user query 204 or user query 504). For example, the user query may include “I want to generate and file a Schedule H form for my nanny, and to download her Schedule H form from last year.” In this example, a processing system identifies functions corresponding to function definitions 604-610 as relevant based on semantic similarity of the user query and function schemas associated with each of these functions. The processing system (e.g., using an LLM 216 or an LLM 516) identifies outputs 612, 614, and 616, and inputs 618 and 620 of the functions according to the corresponding function schemas. The output 612 of function definition 604 is an information request to a user associated with the user query (e.g., “What is the EIN associated with your nanny?”). The input 618 of function definition 606 is a result of the information request (e.g., “12-3456789”). The output 614 of function definition 606 is a generated form (e.g., a Schedule H using the result of the information request). The input 620 of function definition 608 is the generated form. The output 616 of function definition 608 is a filed status for the generated form. Thus, the processing system (e.g., LLM) evaluates the user query to identify a set of functions corresponding to function definitions 604, 606, and 608, and generates a function plan 600 with a planning strategy that indicates that functions corresponding to function definitions 604, 606, and 608 are to be executed in series.

As shown by 622, the planning strategy indicates parallel execution of a function corresponding to function definition 610. “Parallel execution” means that the function corresponding to function definition 610 can be executed without receiving input that is an output of another function or function definition, and not necessarily that the function corresponding to function definition 610 is executed at the same time as another function. Here, the function definition 610 provides an output 624 of a form, such as a previously filed Schedule H form.

Thus, a function plan that involves the execution of multiple functions can be generated by the processing system using the LLM. This reduces processing resource usage relative to an approach where function plans include only a single function, by reducing the number of user queries, iterations of the LLM, and so on. Furthermore, by gracefully generating a function plan that enables the execution of the multiple functions, user intervention is reduced, further conserving processing resources by reducing error rate and improving efficiency of function plan generation.

### Example Method by a Processing System

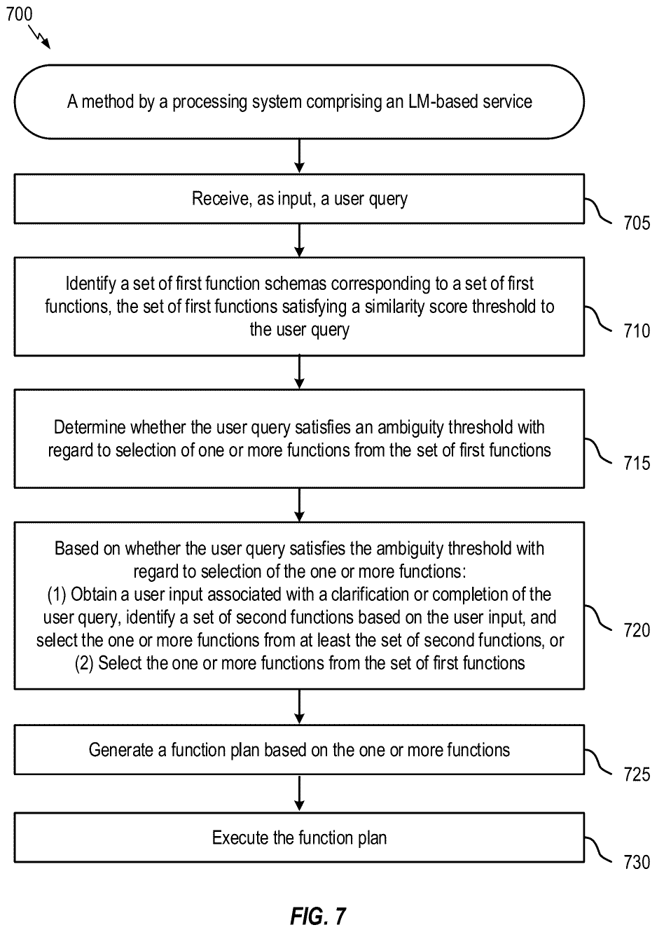

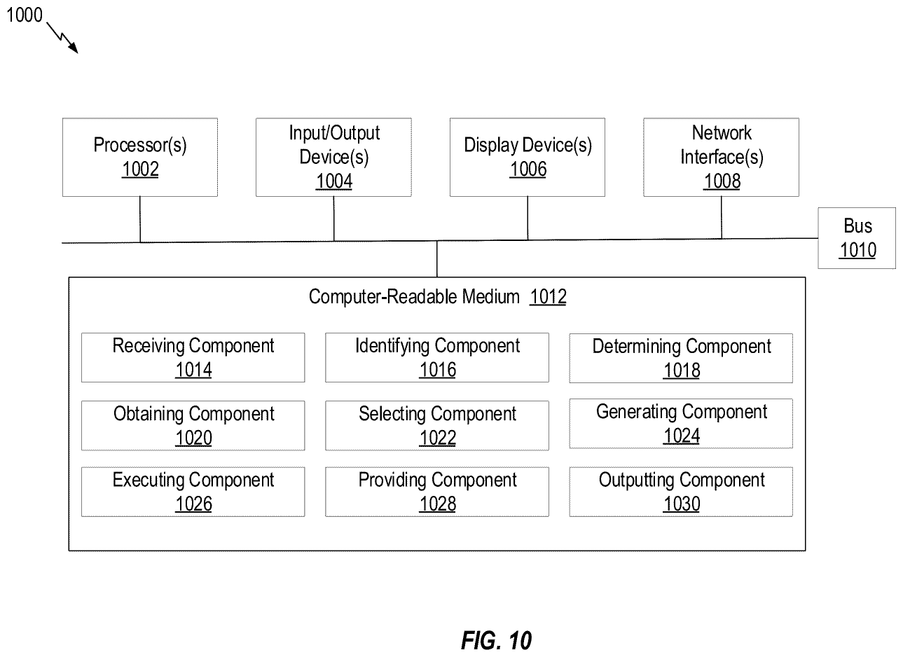

FIG. 7 shows a method 700 by a processing system. In some aspects, method 700 may be performed by an apparatus or processing system, such as system 100, system 102, microservice 104, client device 150, or a processing system 1000 of FIG. 10.

Method 700 begins at block 705 with receiving, as input, a user query (e.g., user query 204, user query 504).

Method 700 then proceeds to block 710 with identifying a set of first function schemas (shown at 212 or 512) corresponding to a set of first functions, the set of first functions satisfying a similarity score threshold (shown at 210 or 510) to the user query.

Method 700 then proceeds to block 715 with determining whether the user query satisfies an ambiguity threshold (shown at 218 or 518) with regard to selection of one or more functions from the set of first functions.

Method 700 then proceeds to block 720 with, based on whether the user query satisfies the ambiguity threshold with regard to selection of the one or more functions: (1) obtaining a user input associated with a clarification or completion of the user query, identifying a set of second functions based on the user input, and selecting the one or more functions from at least the set of second functions (corresponding to “YES” from block 218 or block 518), or (2) selecting the one or more functions from the set of first functions (corresponding to “NO” from block 218 or block 518).

Method 700 then proceeds to block 725 with generating a function plan (such as function plan 222 or function plan 522) based on the one or more functions.

Method 700 then proceeds to block 730 with executing the function plan.

In some aspects, block 720 includes: generating a request for the user input, the request configured to resolve an ambiguity associated with the user query; and providing the request via a user interface.

In some aspects, block 720 includes determining a set of similarity scores for the set of second functions, the similarity scores satisfying the similarity score threshold.

In some aspects, block 720 includes selecting the one or more functions from the set of first functions and the set of second functions.

In some aspects, block 720 includes selecting the one or more functions using a context window that includes the user query, the set of first function schemas, and the user input.

In some aspects, the one or more functions include a plurality of functions, and wherein the function plan indicates for the plurality of functions to be executed as a series of functions.

In some aspects, the function plan indicates for the plurality of functions to be executed in series based on a later function, of the series of functions, receiving an output of an earlier function of the series of functions as an input.

In some aspects, the one or more functions include a plurality of functions, and wherein the function plan indicates for a first function of the plurality of functions and a second function of the plurality of functions to be performed in parallel.

In some aspects, method 700 further includes outputting an indication that the user query satisfies the ambiguity threshold, wherein obtaining the user input is based on the indication.

In some aspects, method 700 further includes outputting an indication that the user query does not satisfy the ambiguity threshold, wherein selecting the one or more functions from the set of first functions is based on the indication.

In some aspects, method 700, or any aspect related to it, may be performed by an apparatus or processing system, such as processing system 1000 of FIG. 10, which includes various components operable, configured, or adapted to perform the method 700. Processing system 1000 is described below in further detail.

Note that FIG. 7 is just one example of a method, and other methods including fewer, additional, or alternative operations are possible consistent with this disclosure.

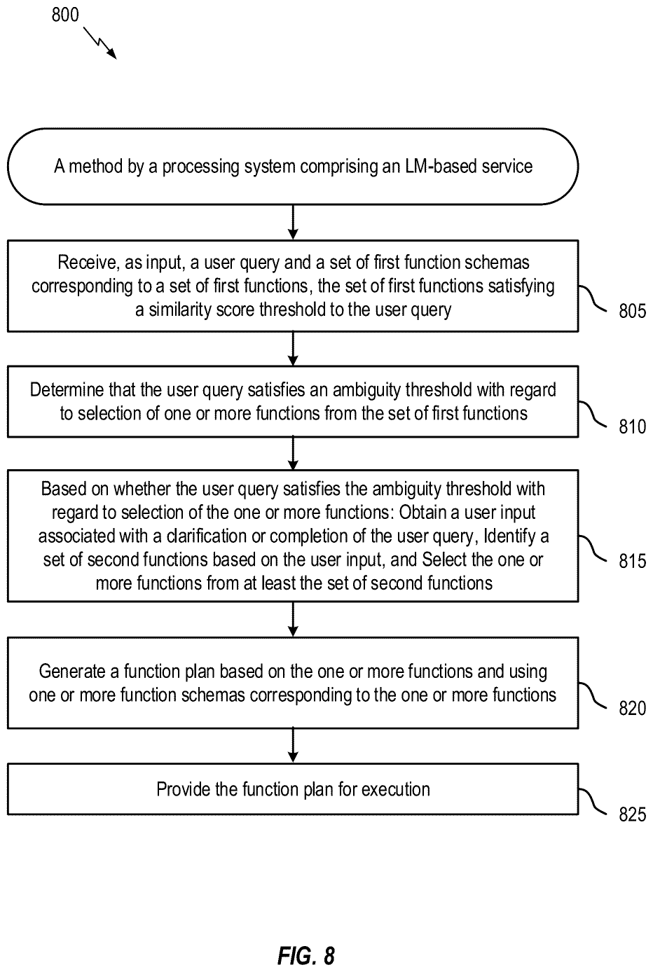

FIG. 8 shows a method 800 by a LM based service. In some aspects, method 800 may be performed by an apparatus or processing system, such as system 100, system 102, microservice 104, client device 150, or a processing system 1000 of FIG. 10.

Method 800 begins at block 805 with receiving, as input, a user query (e.g., user query 204, user query 504 and a set of first function schemas (e.g., function schemas 206, function schemas 506) corresponding to a set of first functions, the set of first functions satisfying a similarity score threshold to the user query (as shown at 212 or 512).

Method 800 then proceeds to block 810 with determining that the user query satisfies an ambiguity threshold (as described with regard to 218 or 518) with regard to selection of one or more functions from the set of first functions.

Method 800 then proceeds to block 815 with, based on whether the user query satisfies the ambiguity threshold with regard to selection of the one or more functions: obtaining a user input associated with a clarification or completion of the user query, identifying a set of second functions based on the user input, and selecting the one or more functions from at least the set of second functions (block 218/518—“NO”).

Method 800 then proceeds to block 820 with generating a function plan (e.g., function plan 222) based on the one or more functions and using one or more function schemas corresponding to the one or more functions.

Method 800 then proceeds to block 825 with providing the function plan for execution.

In some aspects, block 820 includes generating a function definition, the function definition comprising a function name of the one or more functions and a function argument of the one or more functions, and wherein block 825 includes executing the one or more functions in accordance with the function definition.

In some aspects, generating the function plan is based on a function schema, of the set of first function schemas or a set of second function schemas associated with the set of second functions, associated with the one or more functions.

In some aspects, the function schema indicates the function name, and wherein the function argument is in accordance with a function type indicated by the function schema.

In some aspects, the user query satisfying the ambiguity threshold indicates that information for generating a function definition based on the user query is missing from the user query.

In some aspects, method 800, or any aspect related to it, may be performed by an apparatus, such as processing system 1000 of FIG. 10, which includes various components operable, configured, or adapted to perform the method 800. Processing system 1000 is described below in further detail.

Note that FIG. 8 is just one example of a method, and other methods including fewer, additional, or alternative operations are possible consistent with this disclosure.

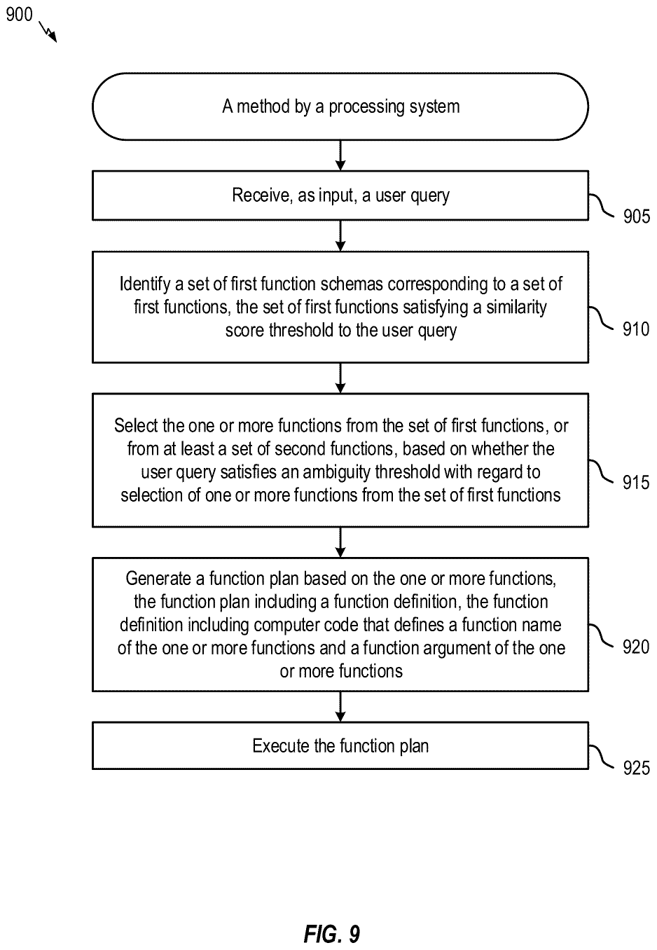

FIG. 9 shows a method 900 by a LM based service. In some aspects, method 900 may be performed by an apparatus or processing system, such as system 100, system 102, microservice 104, client device 150, or a processing system 1000 of FIG. 10.

Method 900 begins at block 905 with receiving, as input, a user query (e.g., user query 204, user query 504).

Method 900 then proceeds to block 910 with identifying a set of first function schemas (shown at 212 or 512) corresponding to a set of first functions, the set of first functions satisfying a similarity score threshold (shown at 210 or 510) to the user query.

Method 900 then proceeds to block 915 with selecting the one or more functions from the set of first functions, or from at least a set of second functions, based on whether the user query satisfies an ambiguity threshold (at 218 or 518) with regard to selection of one or more functions from the set of first functions.

Method 900 then proceeds to block 920 with generating a function plan (e.g., function plan 222) based on the one or more functions, the function plan including a function definition, the function definition including computer code that defines a function name of the one or more functions and a function argument of the one or more functions.

Method 900 then proceeds to block 925 with executing the function plan.

In some aspects, method 900 further includes obtaining a user input associated with a clarification or completion of the user query.

In some aspects, method 900 further includes identifying the set of second functions based on the user input.

In some aspects, method 900 further includes selecting the one or more functions from at least the set of second functions using a context window that includes the user query, the set of first functions, and the set of second functions.

In some aspects, method 900 further includes generating a request for the user input based on information for generating the function definition being missing from the user query.

In some aspects, the one or more functions include a plurality of functions, wherein the function plan indicates an output of a first function of the plurality of functions as a function argument for a second function of the plurality of functions.

In some aspects, the similarity score threshold indicates a threshold for a set of cosine similarity values between the user query and the set of first functions.

In some aspects, method 900, or any aspect related to it, may be performed by an apparatus, such as processing system 1000 of FIG. 10, which includes various components operable, configured, or adapted to perform the method 900. Processing system 1000 is described below in further detail.

Note that FIG. 9 is just one example of a method, and other methods including fewer, additional, or alternative operations are possible consistent with this disclosure.

### Example Processing System for a LM Based Service

FIG. 10 depicts an example processing system 1000 configured to perform various aspects described herein, including, for example, method 700 as described above with respect to FIG. 700, method 800 as described above with respect to FIG. 8, and/or method 900 as described above with respect to FIG. 9.

Processing system 1000 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 1000 includes one or more processors 1002, one or more input/output devices 1004, one or more display devices 1006, one or more network interfaces 1008 through which processing system 1000 is connected to one or more networks (e.g., a local network, an intranet, the Internet, or any other group of processing systems communicatively connected to each other), and computer-readable medium 1012. In the depicted example, the aforementioned components are coupled by a bus 1010, which may generally be configured for data exchange amongst the components. Bus 1010 may be representative of multiple buses, while only one is depicted for simplicity.

Processor(s) 1002 are generally configured to retrieve and execute instructions stored in one or more memories, including local memories like computer-readable medium 1012, as well as remote memories and data stores. Similarly, processor(s) 1002 are configured to store application data residing in local memories like the computer-readable medium 1012, as well as remote memories and data stores. More generally, bus 1010 is configured to transmit programming instructions and application data among the processor(s) 1002, display device(s) 1006, network interface(s) 1008, and/or computer-readable medium 1012. In certain embodiments, processor(s) 1002 are representative of a one or more central processing units (CPUs), graphics processing unit (GPUs), tensor processing unit (TPUs), accelerators, and other processing devices.

Input/output device(s) 1004 may include any device, mechanism, system, interactive display, and/or various other hardware and software components for communicating information between processing system 1000 and a user of processing system 1000. For example, input/output device(s) 1004 may include input hardware, such as a keyboard, touch screen, button, microphone, speaker, and/or other device for receiving inputs from the user and sending outputs to the user.

Display device(s) 1006 may generally include any sort of device configured to display data, information, graphics, user interface elements, and the like to a user. For example, display device(s) 1006 may include internal and external displays such as an internal display of a tablet computer or an external display for a server computer or a projector. Display device(s) 1006 may further include displays for devices, such as augmented, virtual, and/or extended reality devices. In various embodiments, display device(s) 1016 may be configured to display a graphical user interface.

Network interface(s) 1008 provide processing system 1000 with access to external networks and thereby to external processing systems. Network interface(s) 1008 can generally be any hardware and/or software capable of transmitting and/or receiving data via a wired or wireless network connection. Accordingly, network interface(s) 1008 can include a communication transceiver for sending and/or receiving any wired and/or wireless communication.

Computer-readable medium 1012 may be a volatile memory, such as a random access memory (RAM), or a nonvolatile memory, such as nonvolatile random access memory (NVRAM), or the like. In this example, computer-readable medium 1012 includes receiving component 1014, identifying component 1016, determining component 1018, obtaining component 1020, selecting component 1022, generating component 1024, executing component 1026, providing component 1028, and outputting component 1030. Processing of the components 1014-1030 may enable and cause the processing system 1000 to perform: the method 700 as described above with respect to FIG. 7, or any aspect related to it; the method 800 as described above with respect to FIG. 8, or any aspect related to it; and/or method 900 as described above with respect to FIG. 9, or any aspect related to it.

In certain embodiments, receiving component 1014 is configured to receive, as input, a user query, as described in FIG. 7 with reference to block 705. In certain embodiments, identifying component 1016 is configured to identify a set of first function schemas corresponding to a set of first functions, the set of first functions satisfying a similarity score threshold to the user query, as described in FIG. 7 with reference to block 710. In certain embodiments, determining component 1018 is configured to determine whether the user query satisfies an ambiguity threshold with regard to selection of one or more functions from the set of first functions, as described in FIG. 7 with reference to block 715. In certain embodiments, obtaining component 1020 is configured to obtain a user input associated with a clarification or completion of the user query, as described in FIG. 7 with reference to block 720. In certain embodiments, identifying component 1016 is configured to identify a set of second functions based on the user input, as described in FIG. 7 with reference to block 720. In certain embodiments, selecting component 1022 is configured to select the one or more functions from at least the set of second functions, or select the one or more functions from the set of first functions, as described in FIG. 7 with reference to block 720. In certain embodiments, generating component 1024 is configured to generate a function plan based on the one or more functions, as described in FIG. 7 with reference to block 725. In certain embodiments, executing component 1022 is configured to execute the function plan, as described in FIG. 7 with reference to block 730.

In certain embodiments, receiving component 1014 is configured to receive, as input, a user query and a set of first function schemas corresponding to a set of first functions, the set of first functions satisfying a similarity score threshold to the user query, as described in FIG. 8 with reference to block 805. In certain embodiments, determining component 1018 is configured to determine that the user query satisfies an ambiguity threshold with regard to selection of one or more functions from the set of first functions, as described in FIG. 8 with reference to block 810. In certain embodiments, obtaining component 1020 is configured to obtain a user input associated with a clarification or completion of the user query, as described in FIG. 8 with reference to block 815. In certain embodiments, identifying component 1016 is configured to identify a set of second functions based on the user input, as described in FIG. 8 with reference to block 815. In certain embodiments, selecting component 1022 is configured to select the one or more functions from at least the set of second functions, as described in FIG. 8 with reference to block 815. In certain embodiments, generating component 1024 is configured to generate a function plan based on the one or more functions and using one or more function schemas corresponding to the one or more functions, as described in FIG. 8 with reference to block 820. In certain embodiments, providing component 1028 is configured to provide the function plan for execution, as described in FIG. 8 with reference to block 825.

In certain embodiments, receiving component 1014 is configured to receive, as input, a user query, as described in FIG. 9 with reference to block 905. In certain embodiments, identifying component 1016 is configured to identify a set of first function schemas corresponding to a set of first functions, the set of first functions satisfying a similarity score threshold to the user query, as described in FIG. 9 with reference to block 910. In certain embodiments, selecting component 1022 is configured to select the one or more functions from the set of first functions, or from at least a set of second functions, based on whether the user query satisfies an ambiguity threshold with regard to selection of one or more functions from the set of first functions, as described in FIG. 9 with reference to block 915. In certain embodiments, generating component 1024 is configured to generate a function plan based on the one or more functions, the function plan including a function definition, the function definition including computer code that defines a function name of the one or more functions and a function argument of the one or more functions, as described in FIG. 9 with reference to block 920. In certain embodiments, executing component 1022 is configured to execute the function plan, as described in FIG. 9 with reference to block 925.

Note that FIG. 10 is just one example of a processing system consistent with aspects described herein, and other processing systems having additional, alternative, or fewer components are possible consistent with this disclosure.

### Example Clauses

Implementation examples are described in the following numbered clauses:
Clause 1: A method by a LM based service, comprising: receiving, as input, a user query; identifying a set of first function schemas corresponding to a set of first functions, the set of first functions satisfying a similarity score threshold to the user query; determining whether the user query satisfies an ambiguity threshold with regard to selection of one or more functions from the set of first functions; based on the user query satisfying the ambiguity threshold with regard to selection of the one or more functions: obtaining, by the LM-based service, a user input associated with a clarification or completion of the user query, identifying a set of second functions based on the user input, and selecting the one or more functions from at least the set of second functions; generating a function plan based on the one or more functions; and executing the function plan.
Clause 2: The method of Clause 1, wherein the user query satisfies the ambiguity threshold and obtaining the user input comprises: generating a request for the user input, the request configured to resolve an ambiguity associated with the user query; and providing the request via a user interface.
Clause 3: The method of any one of Clauses 1-2, wherein the user query satisfies the ambiguity threshold and identifying the set of second functions comprises determining a set of similarity scores for the set of second functions, the similarity scores satisfying the similarity score threshold.
Clause 4: The method of Clause 3, wherein selecting the one or more functions from at least the set of second functions comprises selecting the one or more functions from the set of first functions and the set of second functions.
Clause 5: The method of Clause 3, wherein selecting the one or more functions from at least the set of second functions comprises selecting the one or more functions using a context window that includes the user query, the set of first function schemas, and the user input.
Clause 6: The method of any one of Clauses 1-5, wherein the one or more functions include a plurality of functions, and wherein the function plan indicates for the plurality of functions to be executed as a series of functions.
Clause 7: The method of Clause 6, wherein the function plan indicates for the plurality of functions to be executed in series based on a later function, of the series of functions, receiving an output of an earlier function of the series of functions as an input.
Clause 8: The method of any one of Clauses 1-7, wherein the one or more functions include a plurality of functions, and wherein the function plan indicates for a first function of the plurality of functions and a second function of the plurality of functions to be performed in parallel.
Clause 9: The method of any one of Clauses 1-8, further comprising outputting an indication that the user query satisfies the ambiguity threshold, wherein obtaining the user input is based on the indication.
Clause 10: The method of any one of Clauses 1-9, wherein the user query is a first user query and the method further comprises: receiving a second user query; identifying a third set of functions; determining that the second user query does not satisfy the ambiguity threshold; and selecting a second one or more functions from the set of third functions, in association with the user query, based on the second user query failing to satisfy the ambiguity threshold.
Clause 11: A computer-implemented method by a LM based service, comprising: receiving, as input, a user query and a set of first function schemas corresponding to a set of first functions, the set of first functions satisfying a similarity score threshold to the user query; determining that the user query satisfies an ambiguity threshold with regard to selection of one or more functions from the set of first functions; based on whether the user query satisfies the ambiguity threshold with regard to selection of the one or more functions: obtaining a user input associated with a clarification or completion of the user query, identifying a set of second functions based on the user input, selecting the one or more functions from at least the set of second functions; generating a function plan based on the one or more functions and using one or more function schemas corresponding to the one or more functions; and providing the function plan for execution.
Clause 12: The method of Clause 11, wherein generating the function plan further comprises generating a function definition, the function definition comprising a function name of the one or more functions and a function argument of the one or more functions, and wherein providing the function plan further comprises executing the one or more functions in accordance with the function definition.
Clause 13: The method of Clause 12, wherein generating the function plan is based on a function schema, of the set of first function schemas or a set of second function schemas associated with the set of second functions, associated with the one or more functions.
Clause 14: The method of Clause 13, wherein the function schema indicates the function name, and wherein the function argument is in accordance with a function type indicated by the function schema.
Clause 15: The method of any one of Clauses 11-14, wherein the user query satisfying the ambiguity threshold indicates that information for generating a function definition based on the user query is missing from the user query.
Clause 16: A method for wireless communications by an apparatus comprising: receiving, as input, a user query; identifying a set of first function schemas corresponding to a set of first functions, the set of first functions satisfying a similarity score threshold to the user query; selecting the one or more functions from the set of first functions, or from at least a set of second functions, based on whether the user query satisfies an ambiguity threshold with regard to selection of one or more functions from the set of first functions; generating a function plan based on the one or more functions, the function plan including a function definition, the function definition including computer code that defines a function name of the one or more functions and a function argument of the one or more functions; and executing the function plan.
Clause 17: The method of Clause 16, further comprising: obtaining a user input associated with a clarification or completion of the user query; identifying the set of second functions based on the user input; and selecting the one or more functions from at least the set of second functions using a context window that includes the user query, the set of first functions, and the set of second functions.
Clause 18: The method of any one of Clauses 16-17, further comprising generating a request for the user input based on information for generating the function definition being missing from the user query.
Clause 19: The method of any one of Clauses 16-18, wherein the one or more functions include a plurality of functions, wherein the function plan indicates an output of a first function of the plurality of functions as a function argument for a second function of the plurality of functions.
Clause 20: The method of any one of Clauses 16-19, wherein the similarity score threshold indicates a threshold for a set of cosine similarity values between the user query and the set of first functions.
Clause 21: A processing system, comprising: a memory comprising computer-executable instructions; and a processor configured to execute the computer-executable instructions and cause the processing system to perform a method in accordance with any one of Clauses 1-20.
Clause 22: A processing system, comprising means for performing a method in accordance with any one of Clauses 1-20.
Clause 23: A non-transitory computer-readable medium storing program code for causing a processing system to perform the steps of any one of Clauses 1-20.
Clause 24: A computer program product embodied on a computer-readable storage medium comprising code for performing a method in accordance with any one of Clauses 1-20.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method by a processing system comprising a language model (LM)-based service, comprising:
receiving, as input, a user query and a set of first function schemas corresponding to a set of first functions;
identifying the set of first function schemas corresponding to the set of first functions;
determining a semantic score based on a function schema of the set of first function schemas and the user query;
determining whether the set of first functions satisfies a similarity score threshold to the user query based on the semantic score;
determining whether the user query satisfies an ambiguity threshold with regard to selection of one or more functions from the set of first functions;
based on the user query satisfying the ambiguity threshold with regard to selection of the one or more functions:
obtaining, by the LM-based service, a user input associated with a clarification or completion of the user query,
identifying a set of second functions based on the user input, and
selecting the one or more functions from at least the set of second functions;
generating a function plan based on the one or more functions; and
executing the function plan.

2. The method of claim 1, wherein obtaining the user input comprises:
generating, by the LM-based service, a request for the user input, the request configured to resolve an ambiguity associated with the user query; and
providing the request via a user interface.

3. The method of claim 1, wherein identifying the set of second functions comprises determining a set of similarity scores for the set of second functions, the similarity scores satisfying the similarity score threshold.

4. The method of claim 3, wherein selecting the one or more functions from at least the set of second functions comprises selecting the one or more functions from the set of first functions and the set of second functions.

5. The method of claim 3, wherein selecting the one or more functions from at least the set of second functions comprises selecting, by the LM-based service, the one or more functions using a context window that includes the user query, the set of first function schemas, and the user input.

6. The method of claim 1, wherein the one or more functions include a plurality of functions, and wherein the function plan indicates for the plurality of functions to be executed as a series of functions.

7. The method of claim 6, wherein the function plan indicates for the plurality of functions to be executed in series based on a later function, of the series of functions, receiving an output of an earlier function of the series of functions as an input.

8. The method of claim 1, wherein the one or more functions include a plurality of functions, and wherein the function plan indicates for a first function of the plurality of functions and a second function of the plurality of functions to be performed in parallel.

9. The method of claim 1, further comprising outputting an indication that the user query satisfies the ambiguity threshold, wherein obtaining the user input is based on the indication.

10. The method of claim 1, wherein the user query is a first user query and the method further comprises:
receiving a second user query;
identifying a third set of functions;
determining that the second user query does not satisfy the ambiguity threshold; and
selecting a second one or more functions from the set of third functions, in association with the user query, based on the second user query failing to satisfy the ambiguity threshold.

11. A computer-implemented method by a processing system comprising a language model (LM)-based service, comprising:
receiving, as input, a user query and a set of first function schemas corresponding to a set of first functions:
determining, by the LM-based service, a semantic score based on a function schema of the set of first function schemas and the user query;
determining, by the LM-based service, whether the set of first functions satisfies a similarity score threshold with regard to the user query based on the semantic score;
determining, by the LM-based service, that the user query satisfies an ambiguity threshold with regard to selection of one or more functions from the set of first functions;
based on the user query satisfying the ambiguity threshold with regard to selection of the one or more functions:
obtaining a user input associated with a clarification or completion of the user query,
identifying a set of second functions based on the user input, and
selecting the one or more functions from at least the set of second functions;
generating a function plan based on the one or more functions and using one or more function schemas corresponding to the one or more functions; and
providing the function plan for execution.

12. The method of claim 11, wherein generating the function plan further comprises generating a function definition, the function definition comprising a function name of the one or more functions and a function argument of the one or more functions, and wherein providing the function plan further comprises executing the one or more functions in accordance with the function definition.

13. The method of claim 12, wherein generating the function plan is based on the function schema, of the set of first function schemas or a set of second function schemas associated with the set of second functions, associated with the one or more functions.

14. The method of claim 13, wherein the function schema indicates the function name, and wherein the function argument is in accordance with a function type indicated by the function schema.

15. The method of claim 11, wherein the user query satisfying the ambiguity threshold indicates that information for generating a function definition based on the user query is missing from the user query.

16. A processing system, comprising: one or more memories comprising computer-executable instructions; and one or more processors configured to execute the computer-executable instructions and cause the processing system to:
receive, as input, a user query and a set of first function schemas corresponding to a set of first functions;
identify the set of first function schemas corresponding to the set of first functions;
determine a semantic score based on a function schema of the set of first function schemas and the user query;
determine whether the set of first functions satisfy a similarity score threshold to the user query based on the semantic score;
select the one or more functions from the set of first functions, or from at least a set of second functions, based on whether the user query satisfies an ambiguity threshold with regard to selection of one or more functions from the set of first functions;
generate a function plan based on the one or more functions, the function plan including a function definition, the function definition including computer code that defines a function name of the one or more functions and a function argument of the one or more functions; and
execute the function plan.

17. The processing system of claim 16, wherein, based on the user query satisfying the ambiguity threshold, the one or more processors are configured to cause the processing system to
obtain a user input associated with a clarification or completion of the user query;
identify the set of second functions based on the user input; and
select the one or more functions from at least the set of second functions using a context window that includes the user query, the set of first functions, and the set of second functions.

18. The processing system of claim 17, wherein the one or more processors are configured to cause the processing system to generate a request for the user input based on information for generating the function definition being missing from the user query.

19. The processing system of claim 16, wherein the one or more functions include a plurality of functions, wherein the function plan indicates an output of a first function of the plurality of functions as a function argument for a second function of the plurality of functions.

20. The processing system of claim 16, wherein the similarity score threshold indicates a threshold for a set of cosine similarity values between the user query and the set of first functions.
